(19) United States
(12) Patent Application Publication
(10) Pub. No.: US 2026/0296714 A1
(43) Pub. Date: Oct. 1, 2026

(54) A RECYCLABLE PACKAGING WITH BARRIER TO OXYGEN AND MOISTURE

(71) Applicant: SOCIÉTÉ DES PRODUITS NESTLÉ S.A., Vevey (CH)

(72) Inventors: Gerhard NIEDERREITER, Vevey (CH); Nicola GALAFFU, Ornex (FR)

(21) Appl. No.: 19/480,536

(22) PCT Filed: Apr. 30, 2024
(86) PCT No.: PCT/EP2024/061918

§ 371 Date: Oct. 31, 2025

(30) Foreign Application Priority Data
May 3, 2023 (DE) 20 2023 102 388.6

(51) Int. Cl. B65D 3/22; B32B 7/06; B32B 7/12; B32B 27/08; B32B 27/10; B32B 27/30; B32B 27/32; B32B 29/00; B65D 77/20

(52) U.S. Cl. CPC B65D 3/22; B32B 7/06; B32B 7/12; B32B 27/08; B32B 27/10; B32B 27/306; B32B 27/32; B32B 29/005; B65D 77/2032; B32B 2255/10; B32B 2255/20; B32B 2255/205; B32B 2255/26; B32B 2307/718; B32B 2307/7244; B32B 2307/7246; B32B 2307/7375; B32B 2307/748; B32B 2439/70

(57) ABSTRACT

The present invention is directed to a packaging item (1) comprising: (i) at least one packaging body (2) having a tubular shape and closed at one of its extremities (4) by a permanent bottom wall (5), to define at least one compartment for packaging contents, and at least one dispensing opening (6) configured to allow the packaged contents to be dispensed from said packaging item (1), said packaging body (2) and bottom wall (5) being made of a multilayer oxygen and moisture barrier laminate comprising a cellulosic support layer, and (ii) a removable closure element (7) being made of an oxygen and moisture barrier laminate comprising a paper layer.

### FIELD OF THE INVENTION

The invention relates to a packaging item comprising a barrier to moisture and oxygen for open shelf life, and a packaged food product.

### BACKGROUND OF THE INVENTION

Packaging items for packaging various types of contents are provided in a variety of different shapes, sizes, and materials. For instance, packaging items made of paper are known from the prior art and are often promoted as being environmentally friendly and more sustainable, e.g., compared with plastic.

However, the existing packaging items made of paper often do not provide the same protection of the contents, e.g., compared with other materials, such as plastic or glass. This may adversely affect one or more properties of the contents, e.g., which may result in a reduced storage life of the contents.

Typically, oxidation and/or moisture intake of the packed contents leads to degradation of the organoleptic properties of said product, which is of course undesirable. In some instances, the food safety can be impaired by transfer of gases and/or moisture through the packaging walls. It is therefore of utmost importance, at least with sensitive food products, to ensure a packaging barrier against gases—in particular oxygen—and moisture.

Moreover, the existing packaging items made of paper often suffer from a reduced structural stability compared with packaging items made from other materials, e.g., plastic or glass. This may adversely affect the handling properties of the packaging items.

Last but not least, packages providing good mechanical resistance, as well as an additional protection against oxidation and/or moisture, suffer complexity and high costs of production.

Hence, in particular in view of the above-identified drawbacks, it is an object of the present invention to provide a packaging item that provides greater mechanical protection to the contents, as well as protection against moisture and oxidation, while being of the simplest and cheapest possible structure. It is a further object of the present invention to provide a packaging item with improved handling properties.

### SUMMARY OF THE INVENTION

In a first aspect, the invention relates to a packaging item as claimed in the appended claims.

More precisely the invention relates to a packaging item comprising:
(i) at least one packaging body having a tubular shape and closed at one of its extremities by a permanent bottom wall, to define at least one compartment for packaging contents, and at least one dispensing opening configured to allow the packaged contents to be dispensed from said packaging item, said packaging body and bottom wall being made of a multilayer oxygen and moisture barrier laminate comprising a cellulosic support layer, and organic and/or inorganic barrier layer(s), the cellulosic support layer of the body having a grammage comprised between 120 and 600g/m², said multilayer laminate having a cellulose content higher than 90%, preferably higher than 95%, more preferably higher than 99%, such that the Oxygen Transmission Rate (OTR) is below 1, preferably below 0.5cm³/m²/day measured at 23 °C and 50% relative humidity (RH), and the Water Vapour Transmission rate (WVTR) is below 1, preferably below 0.5g/m²/day measured at 23 °C and 85% RH,
(ii) a removable closure element being made of an oxygen and moisture barrier laminate comprising a paper layer, at least one organic and/or inorganic barrier layer, the paper layer having a grammage comprised between 30 and 120g/m², and a cellulose content higher than 90%, preferably higher than 95%, more preferably higher than 99%, and such that the Oxygen Transmission Rate (OTR) is below 1, preferably below 0.5cm³/m²/day measured at 23 °C and 50% relative humidity (RH), and the Water Vapour Transmission rate (WVTR) is below 1, preferably below 0.5g/m²/day measured at 23 °C and 85% RH.

The container advantageously includes a dispensing opening configured to allow the packaged contents to be dispensed from the container through. The dispensing opening can be of the type that requires full opening of the package (typically by removing at least one element from the rest of the package).

In one embodiment of the invention, the dispensing opening is closed by a peelable membrane, preferably comprising a pull tab that allows a consumer to tear said peelable membrane open. The peelable membrane is preferably made of a material that is barrier to oxygen and moisture. The barrier material is of a type similar to that of the packaging body, but without a thick paperboard layer and adhesive layer included in the packaging body, such that said membrane remains flexible. An additional capping such as a protective rigid or semi-rigid lid, can be placed optionally over the peelable membrane, at least during transportation and storage.

Preferably, the packaging body has an external diameter in a range of 20 mm to 200 mm, more preferably between 40 and 100 mm such that it allows a comfortable handling with a user hand. More preferably, it has a length in a range of 50 mm to 500 mm, even more preferably 75 mm to 250 mm.

The multilayer oxygen and moisture barrier laminate comprising the cardboard and the organic and/or inorganic barrier layer increases the resistance of the container, and thus of the packaging item, against oxygen and moisture transfer, e.g., compared with the packaging items made of paper which are known from the prior art. This results in greater protection, preservation and/or a greater storage life of the contents within the container.

The cross section of the packaging item main body is generally circular such that the main body is preferably a cylinder. As understood in the context of the present invention, a “cylinder” preferably has circular cross section. However, also other, e.g., polygonal or elliptical base lines (i.e. cross sections) may be considered as “cylindrical” within the frame of the present invention. Preferably, the cylinder is a right cylinder. However, oblique cylinders can also be considered.

As understood in the context of the present invention a “cardboard” is a cellulosic flat structure of one or more paper layer(s) having a grammage comprised between 120 g/m²and 600g/m².

The packaging item, more specifically the container, is configured to house and/or preserve, at least for a certain time period, food material in the compartment, i.e., any material used as food, e.g., edible/drinkable material, or used to make/produce food. The packaged material, e.g., food material, may be liquid and/or solid matter. Preferably, the packaged material is solid, and in flowable format, in particular in powder format. The powder can have various granularity values, from small to coarse diameter particles, or be a mix of large and small diameter powder particles. It can also take the form of kibbles, or solid particle items of various shapes and sizes, which are either individually prepacked food items or not. The type of food product can be of wide range like e.g. coffee particles or solids, potato chips, chocolate solids, petfood kibbles, compacted edible items such as e.g. compacted coffee doses, etc.

Generally, the constitutive elements of a package according to the present invention are chosen within packaging materials comprising a high contents of cellulose, and having barrier properties against oxygen and moisture. Such barrier properties are achieved by incorporating organic and/or inorganic layers in the packaging material structure, such as to provide values of Oxygen Transmission Rate (OTR) below 1, preferably below 0.5cm³/m²/day measured at 23 °C and 50% relative humidity (RH), and values of water vapour transmission rate (WVTR) below 1, preferably below 0.5g/m²/day measured at 23 °C and 85% RH.

In the context of the present invention, any of the barrier layers may be provided as an organic barrier layer, e.g. a barrier layer made a polyethylene vinyl alcohol-type polymer, or a compound thereof (PVOH, EVOH, BVOH, or compounds thereof), in addition to, or alternatively to an inorganic layer.

The thickness of the organic layer, e.g. the thickness of a PVOH layer, may be less than 20 μm, preferably less than 10 μm, or more preferably less than 8 μm. Any organic layers in the structure, if present, are preferably deposited by an aqueous dispersion process, which provides low thickness, easy separation of molecules in a recycling process, and therefore a high compatibility with paper recycling stream processes.

Any inorganic barrier layer, if present in the packaging material structure, may comprise a metal such as aluminum, and/or a metalloid such as SiOx (silicon oxide) or AlOx (aluminium oxide). The barrier layer may also be made from a combination of various layers, e.g. at least one organic layer (e.g. PVOH) and at least one inorganic layer (e.g., aluminum).

In a preferred embodiment of the invention, the packaging body and/or the closure elements at the bottom and at the top, are composed of at least 50 vol % paper, more preferably at least 60 vol % paper, more preferably at least 70 vol % paper, more preferably at least 80 vol % paper, more preferably at least 90 vol % paper, more preferably at least 95 vol % paper.

Importantly, several cardboard-based packaging material structures can be used for manufacturing the body of the present packaging. But generally and preferably, the packaging materials that are used are laminates comprising a high cellulosic contents to achieve recyclability in the paper stream processes, and also contain at least one layer that provides barrier properties against oxygen and/or moisture transfer.

Preferably, at least one of the core container, or the sliding closure element, is manufactured from a multilayer cellulosic material comprising:
a paperboard layer having a grammage between 120 g/m²and 600 g/m²,
an optional adhesive layer having a grammage between 0.5 and 10 g/m²,
a paper layer having a grammage comprised between 30 and 120 g/m²,
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20g/m², preferably in an amount of 1 to 10g/m², more preferably in an amount of 2 to 8 g/m²,
at least one inorganic barrier layer selected within the list of: metals, metalloids, or a combination thereof, said inorganic layer having a thickness comprised between 1 and 100 nm, and
at least one organic heat seal layer made of an acrylic or methacrylic acid polymer or polyolefin grafted with at least one type of ionomer, said heat seal layer being applied by aqueous dispersion coating in an amount comprised between 2 and 20 g/m², preferably in an amount comprised between 4 and 9g/m².

Alternatively, the body of the packaging according to the present invention is manufactured from a multilayer cellulosic material comprising:
a paperboard layer having a grammage between 120 g/m² and 600 g/m²,
an optional adhesive layer having a grammage between 0.5 and 10 g/m²,
a paper layer having a grammage comprised between 30 and 120 g/m²,
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20g/m², preferably in an amount of 1 to 10g/m², more preferably in an amount of 2 to 8 g/m²,
at least one inorganic barrier layer selected within the list of: metals, metalloids, or a combination thereof, said inorganic layer having a thickness comprised between 1 and 100 nm, and
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20g/m², preferably in an amount of 1 to 10g/m², more preferably in an amount of 2 to 8 g/m²,
at least one organic heat seal layer made of a polyolefin applied by extrusion, said heat seal layer being applied in an amount comprised between 2 and 20 g/m², preferably in an amount comprised between 4 and 9g/m².

The closing peelable membrane of the package according to the invention can be made of any suitable barrier material, but preferably from one of the materials described above, without the paperboard and adhesive layers.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic perspective drawing of a package according to the invention;

FIG. 2 is a schematic cut view of a package similar to that of FIG. 1.

### DETAILED DESCRIPTION OF THE INVENTION

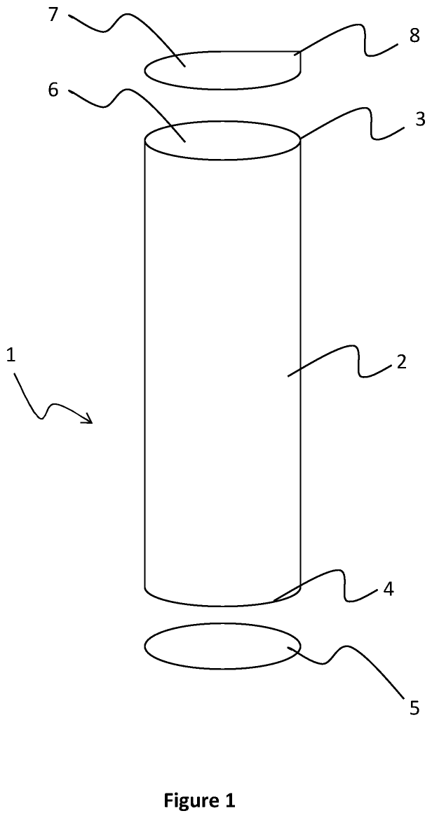

As depicted in FIG. 1, one embodiment of the packaging item 1 according to the present invention comprises a packaging body 2 having a tubular shape with a circular cross-section.

The packaging body 2 is closed at its lower extremity 4 by a bottom wall 5 that is permanently attached to the body 2, such as to define at least one compartment for packaging contents.

At its upper extremity, the body 2 comprises a dispensing opening 6 configured to allow the packaged contents to be dispensed from said packaging item 1. Said packaging body 2 and bottom wall 5 are made of a multilayer oxygen and moisture barrier laminate comprising a cellulosic support layer, an organic and an inorganic barrier layers.

The cellulosic support layer of the body 2 has a grammage comprised between 120 and 600g/m². The cellulosic support layer of the bottom wall 5 has a grammage comprised between 30 and 120g/m², and in this particular embodiment, it is 60g/m².

The multilayer laminate that is used in this embodiment has a cellulose content higher than 95%. The Oxygen Transmission Rate (OTR) is below 0.5cm³/m²/day measured at 23 °C and 50% relative humidity (RH). The Water Vapour Transmission rate (WVTR) is below 0.5g/m²/day measured at 23 °C and 85% RH.

The packaging item embodiment illustrated in FIG. 1 further comprises a removable closure element 7 that is made of an oxygen and moisture barrier laminate comprising:
a paper layer,
an organic oxygen barrier layer, and
an inorganic moisture barrier layer.

The paper layer has a grammage comprised of 62g/m², and a cellulose content higher than 95%.

The Oxygen Transmission Rate (OTR) that is achieved is below 0.5 cm³/m²/day measured at 23 °C and 50% relative humidity (RH), and the Water Vapour Transmission rate (WVTR) is below 0.5g/m²/day measured at 23 °C and 85% RH.

In the embodiment depicted in FIG. 1, the removable closure element 7 is a peelable membrane that comprises a pull tab 8 to facilitate manual removal from the packaging body 2.

The peelable membrane 7 is sealed onto the upper edge 3 of the packaging body 2.

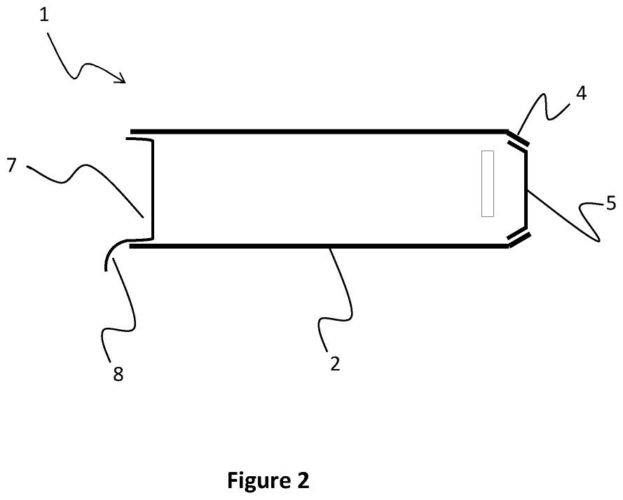

As illustrated in FIG. 2, the packaging item in this embodiment, comprises a flat bottom wall 5 that is sealed to the packaging body 2 by attaching said wall 5 to the internal surface of the packaging body 2, at the lower extremity 4 of the latter.

The peelable membrane 7 can be removably attached by any suitable technique, but advantageously, it is attached to the internal surfaces of the upper extremity 3 of the packaging body 2, such that said membrane 7 protrudes slightly inside said packaging body 2.

Generally, the packaging according to the present invention provides a certain number of advantages and benefits to a user, as follows.

It provides a unique structural design, using a cardboard packaging with unique tube shape, size; the construction is made of cardboard which is recyclable in a paper stream process.

The innovative packaging according to the present invention provides so-called “shelf life” capabilities, which means that before the package is first open for use, its closed configuration allows to preserve a high level of barrier, which provides a long preservation (shelf life) of the contents. This open shelf life is made possible by the fact that moisture and oxygen transfer are minimal when peelable membrane fully closes the container element. In such closed position, the package has values of Oxygen Transmission Rate (OTR) below 1, preferably below 0.5cm 3 /m²/day measured at 23 °C and 50% relative humidity (RH), and values of water vapour transmission rate (WVTR) below 1, preferably below 0.5g/m²/day measured at 23 °C and 85% RH.

It is manufactured out of sustainable material: a tube cardboard packaging made from eco-friendly/biodegradable/recyclable and/or compostable materials, that have built-in barrier capabilities in order to ensure long shelf-life and product freshness without noticeable impact on organoleptic properties.

It comprises customizable features, especially a tube cardboard packaging that can be customized to fit different product types and customer needs, such as size, shape, or color.

It comprises special high barrier functionality against transfer of gases and moisture through its walls. The packaging material that was developed provides high barrier functional properties that enhances the food protection and usability, such as oxygen transmission rate (OTR), moisture resistance (WVTR), odor-blocking properties.

Optionally, but preferably, the packaging material is UV-resistant or light-blocking, hence of particular interest for packing certain food categories which are UV sensitive.

While being resistant to stacking forces and top load mechanical stress (to which packages are subject when transported and stored in piles), the tube packaging uses a cardboard material that is sufficiently flexible so that it can be folded or collapsed, and therefore takes less space after use when it is discarded.

The packaging according to the present invention is a shock-absorbing/cushioning system: the mechanical resilience of the current tube material and the headspace that is integrated into the packaging cavity creates an air pocket feature, so that it protects sensitive products during shipping or handling, against mechanical shocks.

The simple shape of this packaging creates a stackable design that minimizes product movement/optimizes shipping.

The fact that cardboard material is used with a very high contents in cellulose creates a sound dampening effect and reduces noise during transport and while opening closing and reseal. This packaging is very user-friendly to use in that regard.

The preferred shape and diameter of the tube are chosen such that they adapt to a human hand for high ergonomic and easy-grip design.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A packaging item comprising:
(i) at least one packaging body having a tubular shape and closed at one of its extremities by a permanent bottom wall, to define at least one compartment for packaging contents, and the at least one packaging body further comprising at least one dispensing opening configured to allow the packaging contents to be dispensed from the packaging item, the packaging body and the permanent bottom wall comprising a multilayer oxygen and moisture barrier laminate comprising a cellulosic support layer, and the multilayer oxygen and moisture barrier laminate further comprising at least one organic and/or inorganic barrier layer, the cellulosic support layer of the at least one packaging body having a grammage between 120 and 600g/m², the multilayer oxygen and moisture barrier laminate having a cellulose content higher than 90%, such that the Oxygen Transmission Rate (OTR) is below 1 cm³/m²/day measured at 23 °C and 50% relative humidity (RH), and a the Water Vapour Transmission rate (WVTR) is below 1 g/m²/day measured at 23 °C and 85% RH, and
(ii) a removable closure element comprising an oxygen and moisture barrier laminate comprising a paper layer, the oxygen and moisture barrier laminate further comprising at least one organic and/or inorganic barrier layer, the paper layer having a grammage between 30 and 120g/m² and a cellulose content higher than 90%, and such that the Oxygen Transmission Rate (OTR) is below 1 cm³/m²/day measured at 23 °C and 50% relative humidity (RH), and a the Water Vapour Transmission rate (WVTR) is below 1 g/m²/day measured at 23 °C and 85% RH.

2. The packaging item according to claim 1, wherein the said removable closure element comprises a pull tab to facilitate manual removal from the at least one packaging body.

3. The packaging item according to claim 1, wherein the removable closure element is a peelable membrane sealed onto an the upper edge of the at least one packaging body.

4. The packaging item according to claim 1, wherein at least one of the at least one packaging body or the removable closure element comprises multilayer cellulosic material comprising:
a paperboard layer having a grammage between 120 g/m² and 600g/m²,
an optional adhesive layer having a grammage between 0.5 and 10g/m²,
a paper layer having a grammage between 30 and 120g/m²,
at least one organic barrier layer of a polymer selected from the group consisting of: polyvinylalcohol (PVOH), ethylene vinyl alcohol (EVOH), butenediol vinyl alcohol co-polymer (BVOH), and a combination thereof, in an amount of 0.5 to 20g/m²,
at least one inorganic barrier layer selected from the group consisting of: metals, metalloids, and a combination thereof, the at least one inorganic barrier layer having a thickness between 1 and 100 nm, and
at least one organic heat seal layer comprising an acrylic or methacrylic acid polymer or polyolefin grafted with at least one type of ionomer, the at least one organic heat seal layer applied by aqueous dispersion coating in an amount between 2 and 20 g/m².

5. The packaging item according to claim 1, wherein at least one of the at least one packaging body or the removable closure element comprises a multilayer cellulosic material comprising:
a paperboard layer having a grammage between 120 g/m² and 600g/m²,
an optional adhesive layer having a grammage between 0.5 and 10g/m²,
a paper layer having a grammage between 30 and 120g/m²,
at least one organic barrier layer of a polymer selected from the group consisting of: polyvinylalcohol (PVOH), ethylene vinyl alcohol (EVOH), butenediol vinyl alcohol co-polymer (BVOH), and a combination thereof, in an amount of 0.5 to 20g/m²,
at least one inorganic barrier layer selected from the group consisting of: metals, metalloids, and a combination thereof, the at least one said inorganic barrier layer having a thickness between 1 and 100 nm, and
at least one organic barrier layer of a polymer selected from the group consisting of: polyvinylalcohol (PVOH), ethylene vinyl alcohol (EVOH), butenediol vinyl alcohol co-polymer (BVOH), and a combination thereof, in an amount of 0.5 to 20g/m², and
at least one organic heat seal layer comprising of a polyolefin applied by extrusion, the at least one organic heat seal layer applied in an amount between 2 and 20 g/m².

6. The packaging item according to claim 1, wherein the packaging contents:
is an edible product for human and/or animal consumption; and/or
is configured for producing an edible product for human and/or animal consumption.

7. The packaging item according to claim 1, wherein the at least one packaging body and/or the removable closure element is/are composed of at least 50 vol % paper.

8. The packaging item according to claim 1, wherein the packaging body has an external diameter in a range of 20 mm to 200 mm.

9. A packaged food product including:
the packaging item according to claim 1; and
at least one food material contained within the at least one compartment of the packaging item.

10. The packaged food product according to claim 9, wherein the food material is a bulk solid.

11. The packaged food product according to claim 9, wherein the food material is a flowable bulk solid.

12. The packaged food product according to claim 9, wherein the food material is a flowable powder.

13. The packaging item according to claim 1, wherein the at least one packaging body and/or the removable closure element is composed of at least 95 vol % paper.

14. The packaging item according to claim 1, wherein the packaging body has an external diameter in a range of 40 mm to 100 mm.

15. The packaging item according to claim 1, wherein the packaging body has an external diameter in a range of 50 mm to 500 mm.

16. The packaging item according to claim 1, wherein the packaging body has an external diameter in a range of 75 mm to 250 mm.
